(19) United States
(12) Patent Application Publication
(10) Pub. No.: US 2026/0147230 A1
(43) Pub. Date: May 28, 2026

(54) SPECTACLES LENS FOR MANAGING MYOPIA BY MEANS OF INCREASED PERIPHERAL ACTION

(71) Applicant: Rodenstock GmbH, Muenchen (DE)

(72) Inventors: Matthias Rosensteiner, Ismaning (DE); Anne Seidemann, Muenchen (DE); Yohann Bénard, Muenchen (DE); Andrea Welk, Muenchen (DE); Helmut Altheimer, Baisweil-Lauchdorf (DE); Martin Zimmermann, Erdweg-Kleinberghofen (DE); Daniela Babl, Muenchen (DE)

(73) Assignee: Rodenstock GmbH, Muenchen (DE)

(21) Appl. No.: 19/120,584

(22) PCT Filed: Oct. 13, 2023
(86) PCT No.: PCT/EP2023/078481

§ 371 Date: Apr. 11, 2025

(30) Foreign Application Priority Data
Oct. 14, 2022 (DE) 10 2022 210 894.9

(51) Int. Cl. G02C 7/06

(52) U.S. Cl. CPC G02C 7/063

(57) ABSTRACT

A spectacles lens having a specifically shaped peripheral region having differing optical properties for improving long-term wearing comfort while simultaneously improving perception. The spectacles lens includes a continuous channel region that extends continuously from an upper edge to a lower edge of the spectacles lens, and an active region that horizontally adjoins the continuous channel region on both sides and extends continuously from the upper edge to the lower edge of the spectacles lens. The refractive power of the spectacles lens increases from the channel region to the active region on both sides of the channel region.

### CROSS-REFERENCE TO RELATED APPLICATIONS

This application is a national phase application under 35 U.S.C. § 371 of International Patent Application No. PCT/EP 2023/078481, filed Oct. 13, 2023 (pending), which claims the benefit of priority to German Patent Application No. DE 10 2022 210 894.9, filed Oct. 14, 2022, the disclosures of which are incorporated by reference herein in their entirety.

### TECHNICAL FIELD

The invention relates to a spectacles lens having at least one specifically shaped peripheral region having differing optical properties for improving long-term wearing comfort while simultaneously improving perception.

### BACKGROUND

In particular in the case of myopia-correcting spectacles lenses, the frequently observed tendency for myopia to progress leads to a reduction in the wearing comfort of the spectacles lenses once they have been fitted and thus also in the spectacles wearer's satisfaction and the tolerability of the spectacles after a short period of time.

In general, myopia is increasing dramatically worldwide, in particular in Asia. The WHO estimates that by 2050 over 50 percent of all people will be myopic. As an individual's myopia increases, the risk of associated eye diseases such as retinal detachment, glaucoma, cataracts and macular degeneration also increases significantly. Therefore, there is great interest in slowing the increase in myopia. There are several approaches to slowing the progression of myopia using optical aids (seeing aids). What all these approaches have in common, however, is that they are very complex and expensive and also quite inflexible when it comes to adapting them to rapidly changing circumstances (e.g. changes in the prescription of spectacles or visual system requirements).

To date, various optical effects regarding tolerability and comfort of ophthalmic lenses, in particular spectacles lenses, have been examined with regard to their influence on myopia and/or hyperopia as well as their progression or development depending on the optical and physiological mechanisms which are intended to explain or slow down progression or advancement, in particular deterioration. Existing approaches are substantially based on projecting the image in front of the retina, as this is intended to slow down the longitudinal growth of the eye. It has been shown that it is sufficient if this only happens in the periphery of the retina.

One possible approach is the use of bifocal spectacles lenses and/or progressive spectacles lenses (PAL). On the one hand, for far vision, the addition means that a region is projected in front of the retina in the peripheral region and, on the other hand, for near vision, the image is not projected behind the retina, at least if accommodation is too low. This works better in children with accommodative insufficiency and/or convergence excess. However, with such approaches, acceptable results are only achieved for a smaller group with convergence excess. Bifocal spectacles lenses are not desirable, in particular for children, at least for cosmetic reasons.

Another approach is based on special PALs (or radially symmetric PALs) having a central sharply focused projection action and a peripheral addition (e.g. DE 10 2009 053 467 A1).

PALs, as in these two approaches, exhibit regions of large aberrations. Furthermore, the quality of peripheral vision and foveal vision when looking through the periphery of the spectacles lenses is greatly reduced by the aberrations. If high demands are placed on the visual system (e.g. in road traffic), this can only be solved using a second pair of single-vision spectacles. This further increases the effort and costs involved in changing the prescription. The acceptance of such solutions is therefore often low.

Other approaches are based, for example, on special contact lenses. For example, progressive contact lenses having a higher plus effect in the periphery than in the central region have been examined. However, in practice this also means that foveal vision is impaired. In addition, if the strength changes, a new lens must be made at great expense. Furthermore, handling and reliability in handling is limited for children. This is in particular true for young children, and what aggravates this even more is the fact that the greatest effect is actually achieved when measures to slow down myopia begin in early childhood.

Another approach involving contact lenses uses what are known as Ortho-K contact lenses, which are worn overnight and deform the cornea. This is intended to correct myopia centrally and to also create a plus effect in the periphery (compared to centrally). However, every contact lens is custom-made and a new lens has to be manufactured at great expense, for example in the case of a new prescription. Furthermore, the effects of corneal deformities on corneal metabolism and structure are unclear, in particular in young children.

The problem for a spectacles wearer resulting from the advancement of myopia is the steadily decreasing comfort of wearing spectacles once they have been fitted. Special spectacles lenses for myopia control attempt to move the focal plane of the field of vision in the periphery in front of the retina and thus slow down the longitudinal growth of the eye.

Various spectacles lenses have already been proposed which, for example, similar to a progressive lens in the periphery, bring the focal plane in the lateral field of vision in front of the retina by an addition in the action (e.g. U.S. Pat. No. 7,025,460). In particular, there is the approach of having a central zone of good visibility, which is surrounded by an addition in front of the peripheral zone (e.g. W02007041706A1), as well as the possibility of introducing the additional action only in parts of the periphery (e.g. DE102009053467B4). The challenge with these lenses is to find a balance between the effectiveness of the lenses (e.g. with the largest possible regions of peripheral action in front of the retina) and their tolerability (optical comfort defined in particular by the zone of good or acceptable vision as well as by distortions and rocking effects).

### SUMMARY

The object of the present invention is therefore to improve the long-term compatibility of spectacles and thus to achieve long-term and high wearing comfort while simultaneously improving perception. This object is inventively achieved by a spectacles lens having the features specified in the independent claims. Preferred embodiments are the subject of the dependent claims.

The invention therefore relates to a spectacles lens comprising a continuous channel region and an active region such that the (continuous) channel region extends continuously from an upper edge of the spectacles lens to a lower edge of the spectacles lens, and that the active region horizontally adjoins the channel region on both sides and extends continuously from the upper edge to the lower edge of the spectacles lens on both sides. The refractive power of the spectacles lens increases from the channel region to the active region on both sides of the channel region.

The channel region serves in particular as a prescription region, i.e. as a region of clear vision, because this is where the individual prescription data for the correction of a visual impairment (in particular at least refractive power and astigmatism) are implemented in a prescription-like manner.

Compared to spectacles lenses whose central zone is completely surrounded by a plus action, inventive spectacles lenses have the advantage of an enlarged field of vision having sharp perception, while to a surprising extent tolerability is also improved due to an associated significant reduction in distortions in all directions. Compared to conventional spectacles lenses having only a partial plus region, the myopia progression suppressing effect is significantly higher in inventive spectacles lenses.

In other words, these advantages of the inventive spectacles lenses are achieved in that the additional action in particular fills most of the periphery of the spectacles lens, but leaves two specific peripheral regions free which are in particular approximately diametrically opposite: a region which extends downward from the center, in particular slightly offset nasally, in order for the spectacles lens to support near vision, where the eyes assume a convergence position, and a region which extends upward from the center in order to achieve stabilization of the image field and thus ensure tolerability and effectiveness at the same time. The optimal distribution of the regions with and without additional action (compared to the prescription action) in the periphery of the spectacles lens achieves maximum tolerability with good preventive action.

The directions “down” and “up” (and terms related thereto such as “below” and “above”) and terms for “nasal,” “temporal,” “horizontal” and “vertical” directions in this description are always considered in relation to the position of use of the spectacles lens, which is determined in particular by the centering data for the spectacles lens. In this case, the “lower” and “upper” edges of the spectacles lens are preferably understood to mean an edge portion of a lower or upper half, more preferably of a lower or upper third, even more preferably of a lower or upper quarter, of a spectacles lens surface (front surface and/or rear surface) of the spectacles lens. Particularly preferably, an upper or lower edge refers to: in particular a portion of the edge of the entire spectacles lens which delimits the uppermost or lowermost 20 percent, preferably 15 percent, even more preferably 10 percent, most preferably 5 percent, of the vertical height of the spectacles lens. The spectacles lens referred to in this description is a spectacles lens which has already been edged or ground (finished).

A horizontal width of the channel region at the upper edge and at the lower edge of the spectacles lens (or in particular the particular distance of the points at which lateral boundary lines between the channel region and the active region meet the edge of the spectacles lens) is smaller than a maximum horizontal width of the channel region. It is at least preferred, however, if the channel region has a maximum horizontal width in a vertically central region (e.g. a central third in height) of the spectacles lens which is greater than a minimum, preferably maximum, horizontal width of the channel region above, in particular in an upper third in height of the spectacles lens and/or a minimum, preferably maximum, horizontal width of the channel region below, in particular in a lower third in height of the spectacles lens. This leads to a particularly high effectiveness of the active region, which is divided into a nasal active region and a temporal active region by the continuous channel, which is particularly narrow at the top and bottom in particular. In particular, both the nasal active portion and the temporal active portion, considered individually, extend contiguously from the upper edge to the lower edge of the spectacles lens, with both the nasal active portion and the temporal active portion directly adjoining the channel region, in particular along the entire length between the upper edge and the lower edge of the spectacles lens. The refractive power increasing from the channel region to the active region preferably also runs continuously at the transition from the channel region to the active region, in particular on both sides. This ensures a steady visual impression even when the head moves.

Particularly preferably, the maximum refractive power in the nasal active portion and the maximum refractive power in the temporal active portion deviate from one another by not more than approximately 3 dpt, preferably not more than approximately 2 dpt, even more preferably not more than approximately 1 dpt, most preferably not more than approximately 0.5 dpt. Alternatively or simultaneously, the maximum refractive power in both the nasal active region and the temporal active region is, depending on the embodiment and area of application, at least approximately 1 dpt, preferably at least approximately 1.5 dpt, more preferably at least approximately 2 dpt, even more preferably at least approximately 2.5 dpt, most preferably at least approximately 3 dpt, greater than the minimum refractive power in the channel region. The total range of variation of the refractive power between a minimum refractive power in the channel region and a maximum refractive power in the active region preferably also depends on a possible range of variation of the refractive power within the channel region. Therefore, with a nominal “single-vision lens” in which the refractive power varies only slightly over the entire channel region and compensates for the refractive deficit of the corresponding eye described by the prescription with one refractive power value, a sufficient action in the active region can possibly be achieved with a total range of refractive power variation between the channel region and the active region of up to 2 dpt. However, in the event that the channel region already provides, for example, a progressive increase in action downward in the form of a nominal “progressive lens,” the entire range of a refractive power variation between the minimum refractive power in the channel region and the maximum refractive power in the active region could preferably also be larger. In particular, it is preferred if, over the entire length of the channel region between the upper edge and the lower edge of the spectacles lens, the horizontal increase in refractive power toward the active region or within the active region is large enough to stimulate sufficient suppression of myopia progression. Therefore, in particular, the total range of a refractive power variation between the minimum refractive power in the channel region and the maximum refractive power in the active region is at least greater than the addition within the channel region.

In particular, the channel region within the spectacles lens is delimited on both sides by a channel boundary line toward the active region, which channel boundary line can be defined for each horizontal section through the spectacles lens in that the refractive power of the spectacles lens, starting from a position of a minimum refractive power within the channel region along the particular section toward the lateral sides, is first higher than the particular minimum refractive power (within the channel region along the particular section) by a channel tolerance value (which is in particular characteristic of the channel region). Preferably, the (channel-specific) channel tolerance value is in the range of approximately 0.25 dpt to approximately 0.5 dpt, in particular at 0.25 dpt, or at approximately 0.3 dpt or at approximately 0.35 dpt, or at approximately 0.4 dpt or at approximately 0.45 dpt or at approximately 0.5 dpt.

This type of definition of channel boundaries over the course of the channel boundary lines based on horizontal sections through the spectacles lens is particularly advantageous for many preferred embodiments of the invention because it allows the course and extension of the channel region to be substantially independent of the course of the absolute values of the refractive power along the channel region (e.g. in the presence of an addition in the case of a progressive lens, as will be described further below).

In a preferred embodiment, for at least 50 percent, preferably at least 60 percent, even more preferably at least 70 percent, most preferably at least 80 percent, of the height of the spectacles lens, and in each horizontal section, a maximum refractive power in the nasal active portion and/or in the temporal active portion is greater by at least one minimum active value than the minimum refractive power within the channel region along the particular section, wherein the minimum active value is approximately 0.25 dpt, preferably approximately 0.5 dpt, even more preferably approximately 1 dpt, most preferably approximately 1.5 dpt, greater than the minimum refractive power within the channel region or approximately 0.25 dpt, preferably approximately 0.5 dpt, even more preferably approximately 1 dpt, most preferably approximately 1.5 dpt, greater than the channel tolerance value.

In a preferred embodiment, for at least 50 percent, preferably at least 60 percent, even more preferably at least 70 percent, most preferably at least 80 percent or even at least 90 percent, of the height of the spectacles lens, and in each horizontal section, the nasal active portion and/or the temporal active portion has an action increase region directly adjoining the channel region that has a horizontal width of at least 5 mm, preferably at least 10 mm, even more preferably at least 20 mm, within which the refractive power increases (preferably strictly) monotonically starting from the channel region toward the corresponding periphery.

In other words, in a preferred embodiment, for each horizontal sectional plane through the spectacles lens which intersects both the channel region and (in particular on both sides) the active region, a corresponding boundary line can be defined between the channel region and the adjoining active region where the refractive power of the spectacles lens, starting from the minimum refractive power within the channel region in the particular sectional plane (nasal and/or temporal) toward the active region, is first higher by a predetermined value (channel tolerance value) of in particular 0.25 dpt or 0.5 dpt (i.e. higher than said minimum refractive power within the channel region in the particular sectional plane). In other words, the channel region is defined in particular in such a way that its refractive power variation within each horizontal section is not greater than the channel tolerance value of in particular approximately 0.25 dpt or approximately 0.5 dpt.

The channel region is thus in particular completely delimited by, on the one hand, the channel boundary lines on both sides and, on the other hand, the edge of the spectacles lens (in particular the upper edge and lower edge). Particularly preferably, for at least 50 percent, preferably at least 60 percent, even more preferably at least 70 percent, most preferably at least 80 percent, of the height of the spectacles lens, and for each horizontal section through the spectacles lens, the refractive power in the active region increases from the particular channel boundary line up to a particular maximum refractive power by at least approximately 0.25 dpt, preferably by at least approximately 0.5 dpt, even more preferably by at least approximately 1 dpt, most preferably by at least approximately 1.5 dpt.

In a preferred embodiment, the channel region comprises:
a central main visual region;
a near-vision zone arranged below the central main visual region and extending from the central main visual region to the lower edge of the spectacles lens; and
an upper channel portion arranged above the central main visual region and extending from the central main visual region to the upper edge of the spectacles lens.

In a preferred embodiment, the spectacles lens has a substantially constant refractive power throughout the entire channel region, wherein a continuous line exists within the channel region from the upper edge to the lower edge of the spectacles lens, along which the refractive power of the spectacles lens varies by, in particular, not more than approximately 0.5 dpt, preferably not more than 0.25 dpt. Such a spectacles lens therefore acts as a nominal “single-vision lens.”

Particularly preferably, the spectacles lens has a (correspondingly) substantially constant refractive power at least in the central main visual region and in the upper channel portion. In the case of a nominal multifocal or “progressive lens,” it is preferred if the spectacles lens has a higher average refractive power in the near-vision zone than in the central main visual region.

In order to particularly accommodate the convergence of the viewing directions in near vision, it is preferred if the near-vision zone extends from the central main visual region to the lower edge of the spectacles lens along a line, in particular a straight line, which extends from a center (in particular a centroid) of the central main visual region nasally downward at an angle in the range of approximately 0 degrees to approximately 30 degrees, preferably in a range of approximately 5 degrees to approximately 20 degrees, even more preferably in a range of approximately 8 degrees to approximately 15 degrees, relative to the vertical. In particular, a center point (e.g. geometric center of gravity or center of an inscribed circle) of the central main visual region can serve as the center.

Preferably, a horizontal width of the upper channel portion (between the central main visual region and the upper edge of the spectacles lens) is in a range of at least approximately 3 mm, preferably at least approximately 5 mm, even more preferably at least approximately 10 mm, and/or a horizontal width of the upper channel portion (between the central main visual region and the upper edge of the spectacles lens), or at least a minimum horizontal width of the upper channel portion (i.e. at its narrowest point), is preferably in a range of not more than approximately 30 mm, more preferably not more than approximately 20 mm, even more preferably not more than approximately 10 mm.

Preferably, a horizontal width of the near-vision zone (between the central main visual region and the lower edge of the spectacles lens) is in a range of at least approximately 3 mm, preferably at least approximately 5 mm, even more preferably at least approximately 10 mm, and/or a horizontal width of the near-vision zone (between the central main visual region and the lower edge of the spectacles lens), or at least a minimum horizontal width of the near-vision zone (i.e. at its narrowest point) is preferably in a range of not more than approximately 30 mm, preferably not more than approximately 20 mm, even more preferably not more than approximately 10 mm.

In a preferred embodiment, a (maximum) horizontal width of the central main visual region is in a range of at least approximately 5 mm, preferably at least approximately 10 mm, even more preferably at least approximately 15 mm, most preferably at least approximately 20 mm, and/or a (maximum) horizontal width of the central main visual region is in a range of not more than approximately 35 mm, preferably not more than approximately 30 mm, more preferably not more than approximately 25 mm, most preferably not more than approximately 20 mm. A further preferred spectacles lens can be characterized in that the central main visual region comprises a circular area having a radius of at least approximately 3 mm, preferably at least approximately 5 mm, even more preferably at least approximately 8 mm; and/or wherein the central main visual region lies within a circular area having a radius of at most approximately 25 mm, preferably at most approximately 20 mm, even more preferably at most approximately 15 mm, most preferably at most approximately 10 mm. In a further characterization of a preferred embodiment, the active region lies outside a (central) circular area having a radius of at least approximately 10 mm, preferably at least approximately 15 mm, particularly preferably at least approximately 20 mm, even more preferably at least approximately 25 mm, most preferably at least approximately 30 mm, wherein in particular in a spectacles lens according to a preferred embodiment, this circular area lies within the central main visual region.

Preferably, the maximum horizontal width of the central main visual region is greater than the maximum width of the upper channel portion. In addition or alternatively, the maximum horizontal width of the central main visual region is preferably greater than the maximum width of the near-vision zone. This can make it possible to provide the largest possible field of vision with sharp perception in the region of the main visual region, while at the same time keeping any reduction in the active region small. Because the active region is thus increased in a region horizontal to the upper channel portion and/or the near-vision zone, the effectiveness of myopia progression suppression in such spectacles lenses can be significantly higher, while the tolerability of the spectacles lens is improved or at least maintained for the upper channel portion and/or the near-vision zone.

The main visual region is preferably formed in a vertically central region, in particular a central third in height, of the spectacles lens. In particular, the upper channel portion is formed in the uppermost 30 percent, preferably 20 percent, more preferably 15 percent, even more preferably 10 percent, most preferably 5 percent, of the vertical height of the spectacles lens. In particular, the near-vision zone is additionally or alternatively formed in the lowest 30 percent, preferably 20 percent, more preferably 15 percent, even more preferably 10 percent, most preferably 5 percent, of the vertical height of the spectacles lens.

The invention is described in greater detail below by way of preferred embodiments, with reference to the accompanying drawings.

### BRIEF DESCRIPTION OF THE DRAWINGS

The accompanying drawings, which are incorporated in and constitute a part of this specification, illustrate exemplary embodiments of the invention and, together with a general description of the invention given above, and the detailed description given below, serve to explain the principles of the invention.

FIG. 1 is a schematic representation of individual regions on a spectacles lens according to a preferred embodiment;

FIG. 2 is schematic representation of an exemplary refractive power distribution in a spectacles lens according to a preferred embodiment; and

FIG. 3 shows a specific refractive power distribution in a spectacles lens.

### DETAILED DESCRIPTION

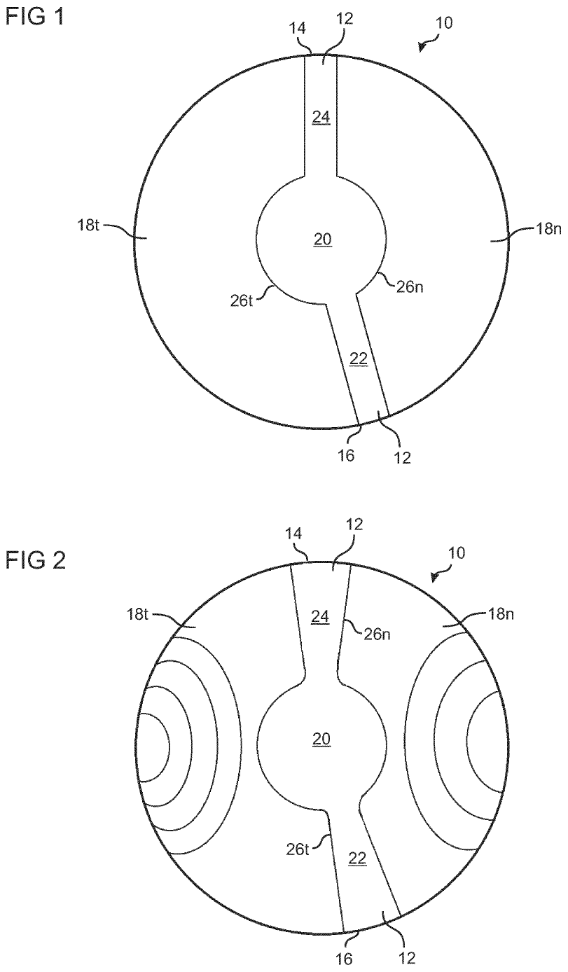

FIG. 1 shows a schematic distribution of individual regions on a spectacles lens 10 according to a preferred embodiment. A channel region 12 extends continuously from an upper edge 14 of the spectacles lens 10 to a lower edge 16 of the spectacles lens 10. When the correct prescription is applied for the corresponding eye, this channel region 12 serves as a clear-vision region or prescription region of the spectacles lens 10 such that the user can see clearly through this region, because this region largely compensates for any visual impairment of the eye.

In the illustrated embodiment, the channel region 12 is schematically divided into three portions, namely:
a central main visual region 20, which can be used by the user in particular to look straight ahead (or to look into the distance toward the horizon),
a near-vision zone 22, which extends from the central main visual region 20 slightly nasally downward to the lower edge 16 of the spectacles lens 10, and
an upper channel portion 24, which extends from the central main visual region 20 to the upper edge 14 of the spectacles lens 10.

In general (i.e. not only in the embodiment shown here), it is preferred if the upper channel portion extends substantially along a vertical line, i.e. runs substantially vertically (in particular unlike the near-vision zone).

This channel region 12 is surrounded nasally and temporally by a nasal active portion 18n and temporal active portion 18t, respectively, which directly adjoin the channel region 12, in particular along a nasal channel boundary line 26n and a temporal channel boundary line 26t, respectively. The two active portions 18n, 18t together form an active region in which the spectacles lens 10 substantially has a higher refractive power compared to the prescription data which are realized in the channel region. In other words, the refractive power of the spectacles lens 10 increases, in particular over the entire length of the channel region 12, from the channel region 12 on both sides toward the active region (or the respective active portions), in particular in the region of the channel boundary lines 26n, 26t.

Within the channel region, however, the refractive power of the spectacles lens is, at least in part, substantially constant. Particularly preferably, the refractive power of the spectacles lens 10 is substantially constant at least in the main visual region 20 and in the upper channel portion 24. To realize a nominal “single-vision lens,” the refractive power of the spectacles lens 10 is preferably substantially constant throughout the entire channel region 12. If, however, the invention is to be used, for example, in connection with a progressive lens effect, the refractive power of the spectacles lens 10 can be higher, at least in the near-vision zone 22, than in the central main visual region 20, in accordance with an addition specified in a prescription (in particular an individual prescription).

As can be seen from the schematic representation of the preferred embodiment of FIG. 1, the central main visual region 20 has a maximum horizontal width (between the channel boundary lines 26n, 26t) which is in particular greater than a minimum horizontal width of the near-vision zone 22 and a minimum horizontal width of the upper channel portion 24. It is precisely the combination of a substantially constant refractive power in the central main visual region 20 and the upper channel portion 24 with the (at least sectionally or partially) narrow channel width in the upper channel portion 24 which achieves a high level of effectiveness for the entire active region in terms of myopia progression suppression combined with a surprisingly good tolerability of the spectacles. In contrast to concepts with active regions which are continuous at the top, the concept described here primarily minimizes distortions and rocking effects. This improvement is achieved both for single-vision lenses (i.e. when the entire channel region 12 has a substantially constant refractive power) and for progressive lenses (i.e. when, in particular, the near-vision zone 22 has an addition).

FIG. 2 is a schematic representation of an exemplary refractive power distribution in a spectacles lens according to a preferred embodiment. This schematic representation could in principle correspond in particular to a spectacles lens 10 from FIG. 1, wherein in FIG. 2 it is apparent from the specific distribution of the refractive power that an embodiment as a single-vision lens is shown here.

Here again, the channel region 12, which comprises the upper channel portion 24, the central main visual region 20 and the near-vision zone 22, extends in this order from the upper edge 14 of the spectacles lens 10 to the lower edge 16 of the spectacles lens. The nasal active portion 18n and the temporal active portion 18t laterally adjoin this channel region 12.

The lines shown in FIG. 2 in addition to the entire edge profile of the spectacles lens represent lines (isolines) of the same refractive power of the spectacles lens 10. For example, the refractive power distances of adjacent lines in FIG. 2 could each describe a difference of 0.5 dpt. As can be seen, the entire channel region lies in a region having substantially constant refractive power, which corresponds precisely to a single-vision lens. The refractive power of the spectacles lens 10 in the channel region does not have to be 0. It can be both positive and negative. In practice, the invention will be particularly relevant in connection with a negative refractive power of the spectacles lens 10 in the channel region, because further myopia progression is more common especially in the case of existing myopia, and the inventive spectacles lenses are particularly suitable here.

Regardless of the absolute value of the refractive power, the spectacles lens 10 in the representation of FIG. 2 has the lowest refractive power in the channel region 12. Toward the lateral active portions 18n, 18t, the refractive power of the spectacles lens 10 then increases continuously and reaches its particular maximum in the schematic representation at approximately mid-height in the region of the lateral edges of the spectacles lens 10.

For preferred embodiments, the course and extent of the channel region 12 can be defined via limit values of the refractive power of the spectacles lens 10. While in the general case, which is particularly advantageous when the present invention is applied to progressive lenses in particular, an above-described comparison of the refractive power can be carried out along horizontal sections, it is also possible, in particular when the invention is applied to single-vision lenses, to apply a global refractive power limit on the basis of the channel tolerance value for defining the course of the channel boundary lines to characterize the channel region 12 of preferred embodiments. Therefore, in a characterization of preferred embodiments of the invention, in particular for use in single-vision lenses, the channel boundary lines could be defined in that the refractive power of the spectacles lens, starting from a position within the channel region 12 toward the lateral active portions, is first higher than a minimum refractive power within the (entire) channel region 12 by the channel tolerance value (which is in particular characteristic of the channel region). Otherwise, the above-described can apply to the channel tolerance value. With reference to the schematic representation in FIG. 2, the two isolines for the smallest marked refractive power could thus be used as channel boundary lines 26n, 26t.

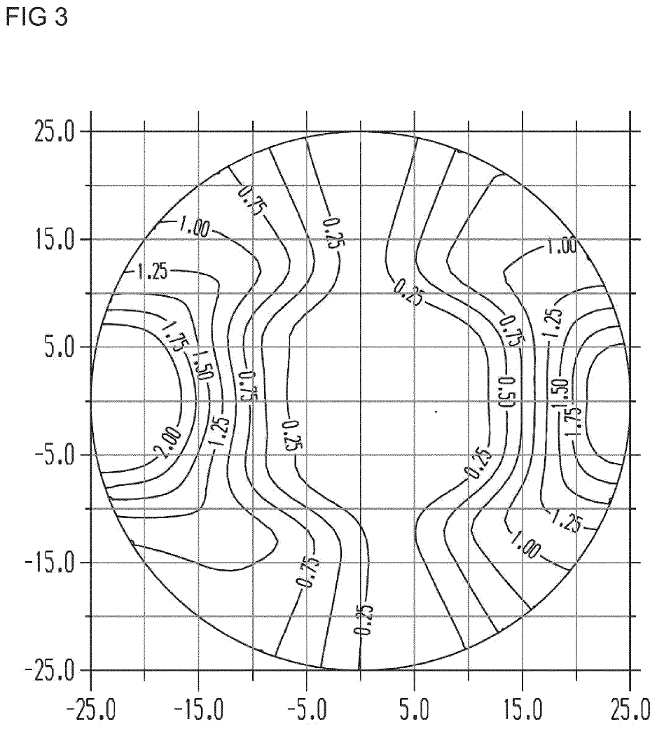

Finally, FIG. 3 shows an exemplary specific refractive power distribution in a spectacles lens according to a preferred embodiment. An exemplary dimension in mm is given on the horizontal and vertical axes, while the isolines connect positions of equal refractive power. The difference in the refractive power values of adjacent isolines is, as can be seen from the labeling, 0.25 dpt in this case. This is also a single-vision lens.

While the present invention has been illustrated by a description of various embodiments, and while these embodiments have been described in considerable detail, it is not intended to restrict or in any way limit the scope of the appended claims to such detail. The various features shown and described herein may be used alone or in any combination. Additional advantages and modifications will readily appear to those skilled in the art. The invention in its broader aspects is therefore not limited to the specific details, representative apparatus and method, and illustrative example shown and described. Accordingly, departures may be made from such details without departing from the spirit and scope of the general inventive concept.

### LIST OF REFERENCE SIGNS

10 spectacles lens
12 channel region
14 upper edge
16 lower edge
18n nasal active portion
18t temporal active portion
20 central main visual region
22 near-vision zone
24 upper channel portion
26n nasal channel boundary line
26t temporal channel boundary line

What is claimed is:

1-17. (canceled)

18. An edged or ground spectacles lens, comprising:
a continuous channel region, which extends continuously from an upper edge to a lower edge of the spectacles lens; and
an active region which horizontally adjoins the continuous channel region on both sides and extends continuously from the upper edge to the lower edge of the spectacles lens;
wherein a refractive power of the spectacles lens increases from the channel region to the active region on both sides of the channel region;
wherein a horizontal width of the channel region at the upper edge and at the lower edge of the spectacles lens is smaller than a maximum horizontal width of the channel region;
wherein the channel region within the spectacles lens is delimited on both sides by a channel boundary line which is defined for each horizontal section through the spectacles lens in that the refractive power of the spectacles lens, starting from a position of a minimum refractive power within the channel region and moving toward the respective active region along the particular section, becomes greater than the minimum refractive power along the particular section by a channel tolerance value; and
wherein the channel tolerance value is in the range of approximately 0.25 dpt to approximately 0.5 dpt.

19. The spectacles lens of claim 18, wherein the channel region has a maximum horizontal width in a vertically central region of the spectacles lens which is at least one of:
greater than a minimum horizontal width of the channel region above; or
greater than a minimum horizontal width of the channel region below.

20. The spectacles lens of claim 18, wherein the active region comprises a nasal active portion and a temporal active portion, each of which is formed contiguously and which are separated from one another by the channel region.

21. The spectacles lens of claim 20, wherein at least one of:
a maximum refractive power in the nasal active portion and a maximum refractive power in the temporal active portion deviate from one another by not more than approximately 3 dpt; or
the maximum refractive power in both the nasal active region and the temporal active region is at least approximately 1 dpt greater than the minimum refractive power in the channel region.

22. The spectacles lens of claim 21, wherein:
for at least 50 percent of the height of the spectacles lens, and in each horizontal section, a maximum refractive power in at least one of the nasal active portion or the temporal active portion is greater by at least one minimum active value than the minimum refractive power within the channel region along the particular section; and
the minimum active value is approximately 0.25 dpt greater than the minimum refractive power within the channel region.

23. The spectacles lens of claim 18, wherein the channel tolerance value is in the range of approximately 0.25 dpt to approximately 0.5 dpt.

24. The spectacles lens of claim 23, wherein the minimum active value is approximately 0.25 dpt greater than the channel tolerance value.

25. The spectacles lens of claim 18, wherein the channel region comprises:
a central main visual region;
a near-vision zone arranged below the central main visual region and extending from the central main visual region to the lower edge of the spectacles lens; and
an upper channel portion arranged above the central main visual region and extending from the central main visual region to the upper edge of the spectacles lens.

26. The spectacles lens of claim 25, wherein the lens has a substantially constant refractive power in the central main visual region and in the upper channel portion.

27. The spectacles lens of claim 25, wherein the lens has a substantially constant refractive power in the central main visual region and in the near-vision zone.

28. The spectacles lens of claim 25, wherein the lens has a higher average refractive power in the near-vision zone than in the central main visual region.

29. The spectacles lens of claim 25, wherein the near-vision zone extends from the central main visual region to the lower edge of the spectacles lens along a line.

30. The spectacles lens of claim 29, wherein the near-vision zone extends along a straight line, from the center of the central main visual region nasally downward at an angle in the range of approximately 0 degrees to approximately 30 degrees relative to vertical.

31. The spectacles lens of claim 30, wherein at least one of:
(a) the near-vision zone extends nasally downward from a centroid of the central main visual region; or
(b) the near-vision zone extends nasally downward at an angle in the range of one of:
approximately 5 degrees to approximately 20 degrees relative to vertical, or
approximately 8 degrees to approximately 15 degrees relative to vertical.

32. The spectacles lens of claim 25, wherein at least one of:
a horizontal width of the upper channel portion is at least approximately 3 mm; or
a horizontal width of the upper channel portion, or at least a minimum horizontal width of the upper channel portion, is not more than approximately 30 mm.

33. The spectacles lens of claim 32, wherein at least one of:
(a) the horizontal width of the upper channel portion is one of:
at least approximately 5 mm, or
at least approximately 10 mm; or
(b) the minimum horizontal width of the upper channel portion is one of:
not more than approximately 20 mm, or
not more than approximately 10 mm.

34. The spectacles lens of claim 25, wherein at least one of:
a horizontal width of the near-vision zone is at least approximately 3 mm; or
a horizontal width of the near-vision zone, or at least a minimum horizontal width of the near-vision zone, is not more than approximately 30 mm.

35. The spectacles lens of claim 34, wherein at least one of:
(a) the horizontal width of the near-vision zone is one of:
at least approximately 5 mm, or
at least approximately 10 mm; or
(b) the minimum horizontal width of the near-vision zone is one of:
not more than approximately 20 mm, or
not more than approximately 10 mm.

36. The spectacles lens of claim 25, wherein at least one of:
a horizontal width of the central main visual region is in a range of at least approximately 5 mm; or
a horizontal width of the central main visual region is in a range of not more than approximately 35 mm.

37. The spectacles lens of claim 36, wherein at least one of:
(a) the horizontal width of the central main visual region is one of:
at least approximately 10 mm,
at least approximately 15 mm, or
at least approximately 20 mm; or
(b) the horizontal width of the central main visual region is one of:
not more than approximately 30 mm,
not more than approximately 25 mm, or
not more than approximately 20 mm.
